(19) United States
(12) Patent Application Publication
(10) Pub. No.: US 2025/0347471 A1
(43) Pub. Date: Nov. 13, 2025

(54) HOUSING OF A HEAT EXCHANGER WITH EXCHANGE CORE BUNDLE

(71) Applicant: VALEO SYSTEMES THERMIQUES, Le Mesnil-Saint-Denis (FR)

(72) Inventors: Laurent Odillard, Le Mesnil-Saint-Denis (FR); Demetrio Onetti, Le Mesnil-Saint-Denis (FR); Alan Day, Le Mesnil-Saint-Denis (FR); Frederic Metezeau, Le Mesnil-Saint-Denis (FR)

(73) Assignee: VALEO SYSTEMES THERMIQUES, Le Mesnil-Saint-Denis (FR)

(21) Appl. No.: 18/871,022

(22) PCT Filed: May 16, 2023
(86) PCT No.: PCT/EP2023/063187

§ 371 Date: Dec. 2, 2024

(30) Foreign Application Priority Data
Jun. 1, 2022 (FR) FR2205270

(51) Int. Cl. F28D 9/00; F28F 3/08; F28F 9/00

(52) U.S. Cl. CPC F28D 9/0037; F28F 3/086; F28F 9/001; F28F 2275/04

(57) ABSTRACT

A heat exchanger includes an exchange core bundle through which a heat-transfer liquid and a gas flow are intended to pass. The exchange core bundle includes a plurality of plates stacked one on another along a stacking direction. The heat exchanger includes a housing surrounding the exchange core bundle and having at least one upper cover plate, a lower cover plate and at least one main side cover plate. The main side cover plate is arranged in the continuation of the upper cover plate and/or of the lower cover plate. The housing includes at least one intermediate side cover plate interposed between the exchange core bundle and the main side cover plate.

The present invention relates to the field of heat exchangers, and more particularly those heat exchangers that are equipped with an exchange core bundle formed of a stack of plates.

Such heat exchangers are intended, for example, to equip vehicles, notably motor vehicles. Within such vehicles, these heat exchangers thermally regulate a first fluid, such as an air flow, circulating through the heat exchanger in a dedicated circulation space by means of a second fluid, such as a cooling liquid, circulating in dedicated channels within the heat exchanger.

Furthermore, motor vehicles are increasingly equipped with a turbocharger for increasing the power of the combustion engine of said vehicles. These turbochargers direct an air flow toward an intake manifold and compress it before this air flow reaches the combustion chamber. This air flow, commonly referred to as “charge air”, makes it possible to supercharge the engine, allowing it to combust the fuel more effectively.

It is known practice to connect a heat exchanger, intended to cool the air flow or “charge air” in order to increase the density of the intake air of the turbocharged engine, to the turbocharger. These heat exchangers, also referred to as “charge-air cooler”, generally have an exchange core bundle formed of a stack of plates between which the charge-air flow circulates. A fluid that communicates with each of the plates by way of channels formed within said plates passes through this stack of plates. An exchange of heat energy can be brought about between the plates, or, if appropriate, between the radiant elements disposed between two adjacent plates, and the charge-air flow.

Such an exchange core bundle is accommodated in a housing surrounding the exchange core bundle. This housing is generally formed of four parts forming cover plates joined to one another so as to form a parallelepiped clamping the exchange core bundle, with two opposite faces of this parallelepiped, which are distinct from the cover plates, being open and intended to be passed through by the charge-air flow. The cover plates are secured to one another by brazing their ends placed against one another. Such a solution tends to experience wear over time at these brazed joins. This wear can, under the effect of the pressure of the charge air circulating through the heat exchanger, cause an opening through which the charge-air flow can escape, reducing the effectiveness of the turbocharger for increasing the power of the combustion engine.

The present invention proposes to overcome the drawbacks of the prior art and notably to limit the formation of openings at the brazed spots joining two cover plates to the housing. The present invention also proposes to improve the mechanical strength of the cover plates with respect to the pressure exerted by the charge-air flow and to make the brazed joins for forming the housing stronger.

In this context, the main subject of the present invention is a heat exchanger comprising an exchange core bundle through which a heat-transfer liquid and a gas flow are intended to pass, the exchange core bundle comprising a plurality of plates stacked one on another along a stacking direction and delimiting, between at least two adjacent plates, at least one circulation duct for the heat-transfer liquid, each circulation duct communicating by way of a first end with a first channel of the exchange core bundle and by way of a second end with a second channel of the exchange core bundle, the heat exchanger comprising a housing surrounding the exchange core bundle and having at least one upper cover plate, a lower cover plate and at least one main side cover plate, the main side cover plate being arranged in the continuation of the upper cover plate and/or of the lower cover plate, characterized in that the housing comprises at least one intermediate side cover plate interposed between the exchange core bundle and the main side cover plate.

The housing of the heat exchanger partially surrounds the exchange core bundle. This housing is a parallelepiped which is open on two opposite faces allowing the gas flow to circulate through the exchange core bundle. The four other faces, forming the various sides of said parallelepiped, are formed by the main side cover plates, the upper cover plate and the lower cover plate. The circulation duct through which a heat-transfer fluid circulates within the exchange core bundle is delimited by a pair of plates, and between each pair of plates the exchange core bundle comprises a circulation space containing heat dissipation means. These heat dissipation means are formed by fins for increasing the exchange surface area between the heat exchanger and the gas flow.

The main side cover plate is disposed in the continuation of the upper cover plate and of the lower cover plate such that the housing is sealed at the junction between these cover plates. More specifically, the main side cover plate is disposed in the continuation of the upper cover plate and of the lower cover plate by alignment of the inner surface of each of these cover plates, this inner surface being the surface of said cover plates that is intended to face the exchange core bundle.

According to one feature of the invention, the first channel and the second channel are formed by stacking the plates in a stacking direction. These channels are formed by the stack of plates; more specifically, a collar for forming a channel is formed at each of the plates. It will be understood that each of the plates comprises two collars for forming the first channel and the second channel when the plates are stacked one on another.

According to one feature of the invention, the intermediate side cover plate has a dimension greater than a dimension of the main side cover plate against which said intermediate side cover plate bears, these dimensions being measured parallel to the stacking direction. It will be understood that the intermediate side cover plate extends beyond the main side cover plate in a direction parallel to the stacking direction of the plates. It should be noted that the intermediate side cover plate bears against the main side cover plate such that these side cover plates are pressed against one another.

According to one feature of the invention, the housing has at least one junction zone between at least one main side cover plate and the upper cover plate and/or the lower cover plate, the intermediate side cover plate extending along the main side cover plate, the lower cover plate and/or the upper cover plate and said junction zone. It will be understood that the intermediate side cover plate completely covers the junction between the main side cover plate and the lower cover plate and/or the upper cover plate. This covering of the junction between these cover plates forms a physical barrier protecting the junction between the main side cover plate and the upper cover plate and/or the lower cover plate.

According to one feature of the invention, the junction zone comprises at least one first brazed join between the intermediate side cover plate and the upper cover plate and/or the lower cover plate, the junction zone comprising a second brazed join between the intermediate side cover plate and the main side cover plate, the junction zone comprising a third brazed join between the main side cover plate and the upper cover plate and/or the lower cover plate. By contrast to the first brazed join and the second brazed join, the third brazed join is an edge-to-edge brazed join between the main side cover plate and the lower cover plate and/or the upper cover plate. This edge-to-edge brazed join makes it possible to be able to align the main side cover plate in the continuation of the upper cover plate and/or the lower cover plate.

According to one feature of the invention, the housing comprises a preassembly means for preassembly between the intermediate side cover plate and the main side cover plate against which said intermediate side cover plate bears. Such a preassembly means advantageously makes it possible, during the assembly of the heat exchanger, to assemble the main side cover plate and the intermediate side cover plate at the same time. It will moreover be understood that the preassembly means makes it possible to ensure that each of said cover plates is positioned precisely relative to the other.

According to one feature of the invention, the preassembly means comprises an interaction between at least one protruding element and one hole, the protruding element being integral with one of the side cover plates and the hole being formed in the other side cover plate. It should be noted that, without departing from the scope of the invention, the protruding element and the hole may be formed on any one of the intermediate or main side cover plates as long as the protruding element is formed on one of the side cover plates and the hole on the other.

According to one feature of the invention, the intermediate side cover plate comprises a first edge in contact with the upper cover plate and a second edge in contact with the lower cover plate.

According to one feature of the invention, the upper cover plate and/or the lower cover plate comprises at least one edge provided with a fillet, the first edge and/or the second edge of the intermediate side cover plate having a complementary rounding to the fillet. It will be understood that the first edge and/or the second edge have a shape that allows the main side cover plate to closely follow the upper cover plate and/or the lower cover plate.

According to one feature of the invention, the housing comprises two intermediate side cover plates, each being connected to a main side cover plate.

Other features, details and advantages of the invention will become more clearly apparent on reading the following description and several exemplary embodiments, which are given by way of non-limiting indication with reference to the appended schematic drawings, in which:

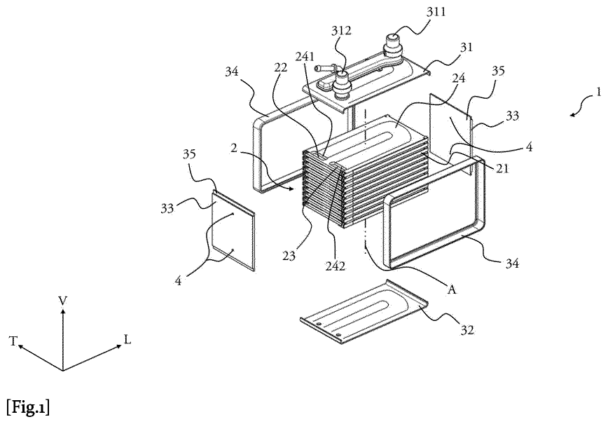

FIG. 1 shows a heat exchanger intended to equip a motor vehicle;

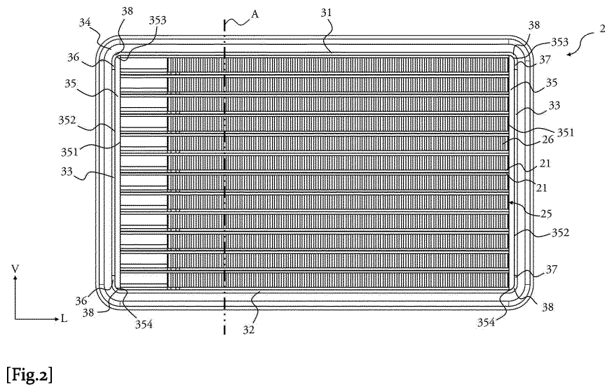

FIG. 2 shows an exchange core bundle of the heat exchanger shown in FIG. 1;

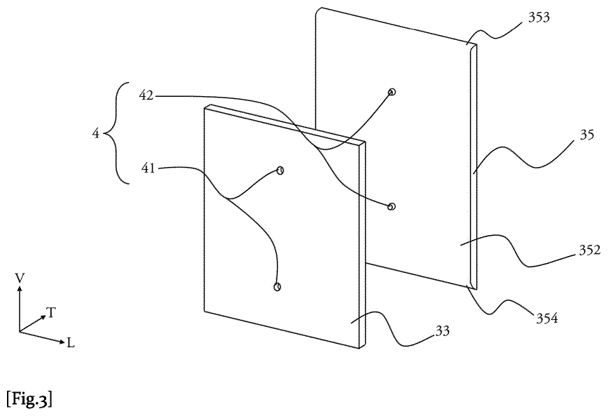

FIG. 3 shows two side cover plates of a housing which accommodates the exchange core bundle shown in FIG. 2;

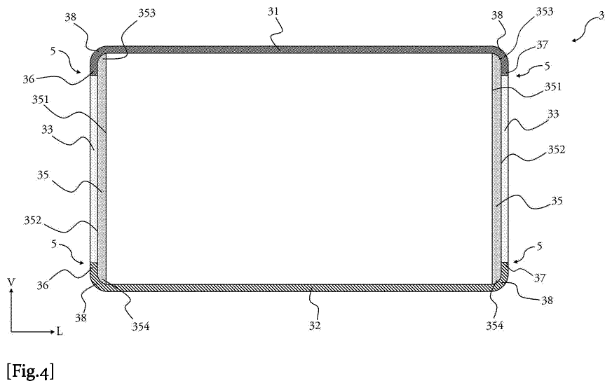

FIG. 4 shows a housing intended to receive the exchange core bundle shown in FIG. 2;

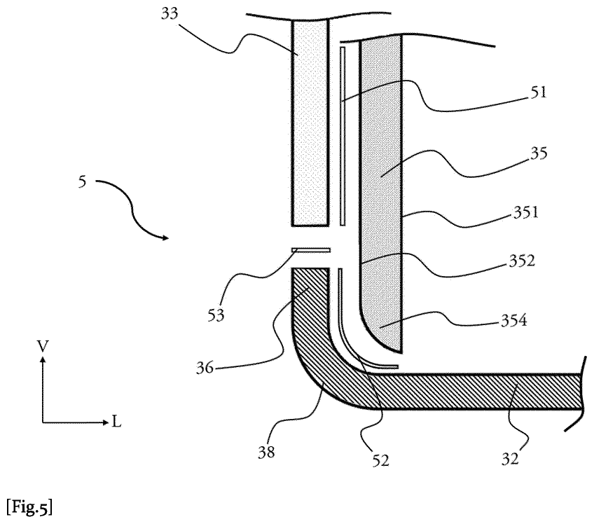

FIG. 5 shows an exploded view of a junction zone of the housing shown in FIG. 4.

The features, variants and different embodiments of the invention may be combined with one another, in various combinations, provided that they are not mutually incompatible or exclusive. In particular, variants of the invention may be envisaged that comprise only a selection of features that are described below in isolation from the other described features, if this selection of features is sufficient to provide a technical advantage or to differentiate the invention from the prior art.

In the figures, elements that are common to several figures retain the same references.

In the following description, reference will be made to an orientation as per the longitudinal axis L, vertical axis V and transverse axis T, as defined arbitrarily by the trihedron L, V, T shown in FIGS. 1 to 5.

FIG. 1 shows a heat exchanger 1 through which a gas flow is intended to pass. In the embodiment shown, this gas flow is an air flow compressed upstream of the heat exchanger 1, which is to say before it enters the heat exchanger 1, by a turbocharger and intended to be delivered to an intake manifold of a combustion engine at the outlet of the heat exchanger 1.

The heat exchanger 1 comprises an exchange core bundle 2 formed of a plurality of plates 21 stacked one on another along a stacking direction A substantially parallel to the axis V. Each of the plates 21 extends in a longitudinal direction of main extent, substantially parallel to the axis L. It will be understood that the plates 21 are stacked one on another in a direction perpendicular to their longitudinal direction of main extent.

The exchange core bundle 2 is accommodated in a housing 3, as shown in a sectional view, isolated from the other elements of the heat exchanger 1, in FIG. 4, having an upper cover plate 31, a lower cover plate 32 opposite the upper cover plate 31, and at least one main side cover plate 33. The at least one main side cover plate 33 is arranged in the continuation of the upper cover plate 31 and of the lower cover plate 32.

It should be noted that, in the embodiment shown, the housing 3 has two main side cover plates 33 allocated to each longitudinal end of the plates 21, which is to say on either side of the exchange core bundle 2 in the longitudinal direction of main extent of the plates 21. It will be understood that the housing 3 at least partially surrounds the exchange core bundle 2 and forms a parallelepiped, four faces of which are formed by the upper cover plate 31, the lower cover plate 32 and the two main side cover plates 33.

Among the faces of said housing 3 forming the parallelepiped, two opposite faces are open and allow the air flow to circulate through the exchange core bundle 2. These two open opposite faces are each connected to an arch 34 through which the air flow is directed so as to circulate through the exchange core bundle 2.

The exchange core bundle 2 is intended to be passed through by a heat-transfer liquid able to bring about an exchange of heat with the air flow. To this end, the upper cover plate 31 comprises an inlet opening 311 for the heat-transfer liquid through which the heat-transfer liquid is able to enter the exchange core bundle 2. This inlet opening 311 is connected to a first channel 22 formed in the exchange core bundle 2 in the stacking direction A of the plates 21. The upper cover plate 31 comprises an outlet opening 312 for the heat-transfer liquid through which the heat-transfer liquid is able to leave the exchange core bundle 2. This outlet opening 312 is connected to a second channel 23 which, like the first channel 22, is formed in the exchange core bundle 2 in the stacking direction A of the plates 21.

Two adjacent plates 21 of the exchange core bundle 2 that are stacked one against the other in the stacking direction A together contribute to delimiting a circulation duct 24 for the heat-transfer liquid. This circulation duct 24 communicates with the first channel 22 by way of a first end or inlet end 241 and with the second channel 23 by way of a second end or outlet end 242. It will be understood that the heat-transfer liquid entering the heat exchanger 1 through the inlet opening 311 in the upper cover plate 31 circulates in the exchange core bundle 2 via the first channel 22 and is distributed in each circulation duct 24 formed between two adjacent plates 21. The heat-transfer liquid circulates from the inlet end 241 of the circulation duct 24 to the outlet end 242 of said circulation duct 24 communicating with the second channel 23 connected to the outlet opening 312 in the upper cover plate 31 through which the heat-transfer liquid is able to leave the heat exchanger 1.

In addition, the housing 3 comprises, according to the invention, at least one intermediate side cover plate 35 interposed between the exchange core bundle 2 and the at least one main side cover plate 33. In the embodiment shown, the housing 3 comprises two main side cover plates 33 each being connected to an intermediate side cover plate 35 interposed between one of the main side cover plates 33 and the exchange core bundle 2. At these side cover plates 33 and 35, an interaction formed by a preassembly means 4, shown more particularly in FIG. 3, makes it possible to position the main side cover plate 33 relative to the intermediate side cover plate 35.

FIG. 2 illustrates a view of the exchange core bundle 2 in the transverse direction, which is to say in a direction parallel to the axis T. As mentioned above, the exchange core bundle 2 comprises a plurality of plates 21 stacked one on another in the stacking direction A. Two adjacent plates 21, delimiting a circulation duct 24 between them, are separated from two other plates 21, also delimiting a circulation duct 24, by a circulation space 25 for the gas flow. In the embodiment shown, this circulation space 25 is partially filled by radiant elements 26.

The radiant elements 26 are formed by a corrugated metal sheet extending mainly in the longitudinal direction L, which is to say along the axis L, substantially parallel to the plates 21. While the heat exchanger 1 is in operation and when the air flow is passing through the circulation space 25, an exchange of heat is brought about between the metal wall, forming the radiant elements 26, and the air flow such that the heat from the metal wall is exchanged with the heat-transfer liquid circulating in the circulation duct 24 delimited between two adjacent plates 21. It should be noted that the shape of the radiant elements 26 makes it possible to increase the exchange surface area between the metal wall and the air flow. Of course, the radiant elements 26 may take other forms as long as these forms make it possible to increase the exchange surface area between the metal wall and the air flow and thus increase the amount of heat able to be transferred to the heat-transfer liquid.

As mentioned above, the exchange core bundle 2 comprises two intermediate side cover plates 35, each being connected to a main side cover plate 33. These intermediate side cover plates 35 extend in a vertical direction, which is to say parallel to the stacking direction A, over the entire height of the exchange core bundle 2, the height being defined as the dimension of elongation of the object in question in a vertical direction parallel to the axis V.

More specifically, these intermediate side cover plates 35 have an inner face 351 intended to face the exchange core bundle 2 and an outer face 352, opposite the inner face 351, intended to at least partially face a connected main side cover plate 33.

Each of the main side cover plates 33 is disposed in the continuation of the lower cover plate 32 and/or of the upper cover plate 31. To this end, the upper and lower cover plates 31 and 32, extending, in the embodiment shown, in a longitudinal direction of main extent between a first longitudinal end 36 and a second longitudinal end 37, have at least one edge forming a fillet 38 allowing the first and second longitudinal ends 36 and 37 to extend in a vertical direction perpendicular to the stacking direction A. Such a fillet 38 allows the main side cover plates 33 to be disposed in the continuation of the upper cover plate 31 and of the lower cover plate 32.

The intermediate side cover plates 35 are in contact with the upper and lower cover plates 31 and 32, more particularly at the fillet 38. As shown in FIG. 5, the portion of the intermediate side cover plates 35 in contact with the upper and lower cover plates 31 and 32 at the fillet 38 has a complementary shape to the fillet 38. More specifically, each intermediate side cover plate 35 comprises a first edge 353 forming a rounding having a complementary shape to the fillet 38 of the upper cover plate 31 and intended to be in contact with the latter. Each intermediate side cover plate 35 also comprises a second edge 354, opposite the first edge 353, forming a rounding having a complementary shape to the fillet 38 of the lower cover plate 32 and intended to be in contact with the latter.

In addition, it will be understood that each intermediate side cover plate 35 extends beyond the connected main side cover plate 33 in a vertical dimension measured parallel to the stacking axis A. In other words, the intermediate side cover plate 35 has a greater dimension in the stacking direction A of the plates 21 than a dimension of the main side cover plate 33 against which said intermediate side cover plate 35 bears.

FIG. 3 illustrates an intermediate side cover plate 35 and a main side cover plate 33 against which the intermediate side cover plate 35 bears. The housing 3, and more particularly the main side cover plate 33 and the intermediate side cover plate 35, has a preassembly means 4. This preassembly means 4 is formed by the interaction between at least one hole and one protruding element. More specifically, in the embodiment shown, the preassembly means 4 is formed by the interaction between two holes 41 formed in the main side cover plate 33 and two protruding elements 42 of the intermediate side cover plate 35. A protruding element 42 of the intermediate side cover plate 35 is intended to be accommodated in a hole 41 of the main side cover plate 33. To this end, the holes 41 advantageously have a round shape which complements the shape of the protruding elements 42 and of which the diameter is substantially equal to the diameter of the protruding elements 42.

The preassembly means 4 advantageously makes it possible to precisely position the intermediate side cover plate 35 so as to bear against the main side cover plate 33. It will be understood that the preassembly means 4 comprising two holes 41 interacting with two protruding elements 42 advantageously makes it possible to prevent a movement of one of the side faces 33, 35 relative to the other both in a direction parallel to the axis L and in a direction parallel to the axis V.

It should be noted that in the embodiment shown, the protruding elements 42 extend from the outer face 352 of the intermediate side cover plate 35 toward the main side cover plate 33. Of course, these protruding elements 42 may extend from any one of the side cover plates 33, 35 toward the connected side cover plate 33, 35 comprising holes 41 able to receive the protruding elements 42.

FIG. 4 schematically illustrates a cross section of the housing 3 isolated from the heat exchanger 1. More particularly, FIG. 4 illustrates junction zones 5 where the intermediate side cover plate 35, the main side cover plate 33 and the upper cover plate 31 and/or the lower cover plate 32 are secured to one another. These junction zones 5 are located at the first and second longitudinal ends 36 and 37 of the upper cover plate 31 and of the lower cover plate 32.

As mentioned above, the main side cover plate 33 is disposed in the continuation of the lower cover plate 32 and of the upper cover plate 31. This disposition is such that that face of the main side cover plate 33 that is intended to be in contact with the intermediate side cover plate 35 is in the continuation of that face of the lower cover plate 32 or of the upper cover plate 31 that is intended to be in contact with the intermediate side cover plate 35, and more particularly the inner face 352 of this intermediate side cover plate 35.

It will be understood that the junction between the main side cover plate 33 and the upper cover plate 31 or the lower cover plate 32 makes it possible to form a smooth surface against which the outer face 352 of the intermediate side cover plate 35 bears.

At each junction zone 5, the main side cover plate 33, the intermediate side cover plate 35 and the lower cover plate 32 or the upper cover plate 31 are brazed against one another by a brazing process at a very high temperature.

FIG. 5 illustrates a junction zone 5 between the main side cover plate 33, the connected intermediate side cover plate 35 and the lower cover plate 32. More specifically, FIG. 5 illustrates an exploded view of said junction zone 5, in which the intermediate side cover plate 35, the main side cover plate 33 and the lower cover plate 32 are separated from one another. It should be noted that the following description with regard to a junction zone 5 of the housing 3 applies, mutatis mutandis, to each junction zone 5 of the housing 3.

The brazing of the intermediate side cover plate 35, of the main side cover plate 33 and of the lower cover plate 32 is carried out by heating a coating interposed between two of said cover plates 33, 35, 32 to a high temperature. To this end, the junction zone 5 comprises a first coating 51 disposed between the intermediate side cover plate 35 and the main side cover plate 33 and a second coating 52 disposed between the lower cover plate 32 and the intermediate side cover plate 35. It will be understood that FIG. 5 illustrates a junction zone 5 before the housing 3 has been heated to a very high temperature. When the housing 3, comprising the coatings 51 and 52, is heated to a very high temperature, a third coating 53 is formed by migration, notably of a portion of the first and second coatings 51, 52, said third coating 53 being disposed between the main cover plate 33 and the lower cover plate 32. Each of the coatings 51, 52 and 53 then forms a polymerized layer secured between two adjacent cover plates. The melting of the sacrificial layers, namely the first coating 51 and the second coating 52, the formation of the third coating 53 and the mixing of said first, second and third coatings 51, 52, 53 ensure the securing of the parts in question once they are cooled.

The first coating 51 is disposed so as to be in contact with the outer face 352 of the intermediate side cover plate 35 and the face of the main side cover plate 33 facing the outer face 352 of the intermediate side cover plate 35. The second coating 52 is disposed at the first longitudinal end 36 of the lower cover plate so as to be in contact with the outer face 352 of the intermediate side cover plate 35 and the lower cover plate 32 and between the fillet 38 of the lower cover plate and the second edge 354 of the intermediate side cover plate 35 forming a complementary rounding to the fillet 38. The third coating 53 is, by contrast to the first coating 51 and the second coating 52, formed between the main side cover plate 33 and the first longitudinal end 36 of the lower cover plate such that the brazed join formed by this third coating 53 is an edge-to-edge brazed join between the main side cover plate 33 and the lower cover plate 32.

It will be understood that the housing 3 comprises, at least at each junction zone 5, a first brazed join between the intermediate side cover plate 35 and the upper cover plate 31 and/or the lower cover plate 32, a second brazed join between the intermediate side cover plate 35 and the main side cover plate 33, and a third brazed join between the main side cover plate 33 and the upper cover plate 31 and/or the lower cover plate 32. The securing of the various cover plates at each junction zone 5 allows the housing 3 to be hermetically closed at each of the distinct faces of the faces through which the gas flow enters the exchange core bundle 2.

The invention, as has just been described, does indeed achieve its stated objectives, and makes it possible to propose a heat exchanger within which the side cover plates of the housing are hermetically reinforced. Variants which are not described here may be implemented without departing from the context of the invention, provided that, in accordance with the invention, they comprise a heat exchanger in which an intermediate side cover plate is interposed between the exchange core bundle and a main side cover plate.

1. A heat exchanger comprising:
an exchange core bundle through which a heat-transfer liquid and a gas flow are intended to pass, the exchange core bundle comprising:
a plurality of plates stacked one on another along a stacking direction
and delimiting, between at least two adjacent plates; and
at least one circulation duct for the heat-transfer liquid,
wherein each circulation duct communicating by way of a first end with a first channel of the exchange core bundle and by way of a second end with a second channel of the exchange core bundle; and
a housing surrounding the exchange core bundle, the housing comprising:
at least one upper cover plate,
a lower cover plate,
at least one main side cover plate,
wherein the main side cover plate is arranged in a continuation of the upper cover plate and/or of the lower cover plate, and
at least one intermediate side cover plate interposed between the exchange core bundle and the main side cover plate.

2. The heat exchanger as claimed in claim 1,
wherein the first channel and the second channel are formed by stacking the plates in a stacking direction.

3. The heat exchanger as claimed in claim 2,
wherein the intermediate side cover plate has a dimension greater than a dimension of the main side cover plate against which said intermediate side cover plate bears, these dimensions being measured parallel to the stacking direction.

4. The heat exchanger as claimed in claim 1,
wherein the housing has at least one junction zone between at least one main side cover plate and the upper cover plate and/or the lower cover plate,
wherein the intermediate side cover plate extending along the main side cover plate, the lower cover plate and/or the upper cover plate and said junction zone.

5. The heat exchanger as claimed in claim 4, wherein the junction zone comprises:
at least one first brazed join between the intermediate side cover plate and the upper cover plate and/or the lower cover plate;
a second brazed join between the intermediate side cover plate and the main side cover plate; and
a third brazed join between the main side cover plate and the upper cover plate and/or the lower cover plate.

6. The heat exchanger as claimed in claim 1, wherein the housing comprises a preassembly means for preassembly between the intermediate side cover plate and the main side cover plate against which said intermediate side cover plate bears.

7. The heat exchanger as claimed in claim 6,
wherein the preassembly means comprises an interaction between at least one protruding element and one hole,
wherein the protruding element is integral with one of the side cover plates and the hole is formed in the other side cover plate.

8. The heat exchanger as claimed in claim 1, wherein the intermediate side cover plate comprises:
a first edge in contact with the upper cover plate; and
a second edge in contact with the lower cover plate.

9. The heat exchanger as claimed in claim 8,
wherein the upper cover plate and/or the lower cover plate comprises at least one edge provided with a fillet,
wherein the first edge and/or the second edge of the intermediate side cover plate having a complementary rounding to the fillet.

10. The heat exchanger as claimed in claim 1 wherein the housing comprises two intermediate side cover plates, each being connected to a main side cover plate.
